(19) United States
(12) Patent Application Publication
(10) Pub. No.: US 2007/0013208 A1
(43) Pub. Date: Jan. 18, 2007

(54) Adjustable door kit assembly

(76) Inventor: Spencer Krumholz, Ft. Lauderdale, FL (US)

Correspondence Address: DANIEL S. POLLEY, P.A., 1215 EAST BROWARD BOULEVARD, FORT LAUDERDALE, FL, 33301, US

(21) Appl. No.: 11/253,135

(22) Filed: Oct. 17, 2005

Related U.S. Application Data
(60) Provisional application No. 60/619,129, filed on Oct. 15, 2004.
(60) Provisional application No. 60/624,276, filed on Nov. 2, 2004.

(51) Int. Cl. B60J 5/04

(52) U.S. Cl. 296/146.12

(57) ABSTRACT

The present invention relates to a universal vehicle door replacement kit assembly including a hinge mechanism allowing a vehicle door to operate in a swing-wing manner, with an adjustable outward and upward motion. A structurally formed door plate/mounting bracket and a base plate/mounting bracket enables simple adjustment to attach the kit to a variety of automobiles without templates and optionally bolting or welding attachment mechanism. Multiple adjustable piston positions allow accommodation of a wide range of door masses.

### PRIOR APPLICATIONS

This application claims priority from U.S. Provisional App. Ser. No. 60/619,128 filed Oct. 15, 2004, and from U.S. Provisional App. Ser. No. 60/624,276 filed Nov. 11, 2004, the entire contents of each are incorporated fully herein by reference.

### BACKGROUND OF THE INVENTION

1. Field of the Invention

The present invention relates to a kit for a replacement door hinge assembly. More specifically, the present invention relates to a convenient replacement door hinge kit for vehicles allowing adjustment of an outward and an upward pivoting motion.

2. Description of the Related Art

Model specific swing-arm type door opening mechanisms are known from Lamborghini sports cars, and are consequently commonly called “lambo doors.” Lambo doors have hinge mechanisms that allow the vehicle door to pivot both outwardly and upwardly in a stylish manner appealing to the consuming public of these extremely high-priced and rare sport cars.

Lamborghini sports cars are custom-crafted to the particular automobile model (Countach/Mura etc.), are custom fitted for size, are very expensive, and consequently unavailable to a common consuming car enthusiast. While many consumers admire the stylish action of the lambo door, few can afford such an automobile. The hinge mechanism of a Lamborghini door is custom-fitted, complex, costly, difficult to work with.

Previous attempts have been made to replicate the lambo style door hinge operation with automotive aftermarket hinge kits specifically designed to match a unique manufacturer's frame/door/roof design. These kits are commercially available for each individual manufacturer and make of car, from Ford Mustangs, to Honda Civics. These kits contain door hinge assemblies pre-crafted and drilled to uniquely match the outward curve and angular set of a particular door, a particular care frame, and a particular car style. These conventional kits are also supplied with substantial unique distinguishing features required for each make of car. For example, the hinge attaching mechanism for previously know lambo-style doors include a hinge mounting bracket shaped and drilled specifically to match the specific conventional automobile hinge it replaces.

This additional effort greatly increases the cost for replacement lambo-style door hinge assemblies, since each must be manufactured individually to a particular custom mounting mechanism for each automobile model, and thereafter individually drilled and tapped to match a specific vehicle make and model.

What is not appreciated by the prior art is the need for an adjustable door kit assembly readily adapted to the most popular automobiles, and readily installed by most individual automobiles.

Accordingly, there is a need for an improved adjustable door assembly kit that overcomes at least one of the detriments in the related art.

### OBJECTS AND SUMMARY OF THE INVENTION

One object of the present invention is to provide an adjustable door kit assembly that responds to at least one of the needs noted above.

Another proposed object of the present invention is to provide a swing-wing style door kit that is easily adapted across a wide spectrum of vehicle makes and models that enables simple bolt-on or weld-on assembly.

Another proposed object of the present invention is to provide an invention allowing kit suppliers to reduce inventory stocks and subsequently inventory costs by supplying the same product to any customer within the consuming public.

Another proposed object of the present invention is to provide a unique door kit with a unique hinge assembly that allows hinge suppliers to lower costs and attempt to meet the demand from the automotive aftermarket.

The present invention relates to a vehicle door replacement kit assembly including a hinge mechanism allowing a vehicle door to operate in a swing-wing style and manner, with a slight outward and then upward motion, and full adjustability in open, rise, and swing orientations.

According to an embodiment of the present invention there is provided a

The present invention relates to a universal vehicle door replacement kit assembly including a hinge mechanism allowing a vehicle door to operate in a swing-wing manner, with an adjustable outward and upward motion. A structurally formed door plate/mounting bracket and a base plate/mounting bracket enables simple adjustment to attach the kit to a variety of automobiles without templates and optionally bolting or welding attachment mechanism. Multiple adjustable piston positions allow accommodation of a wide range of door masses.

According to one embodiment of the present invention, there is provided an adjustable door kit assembly, comprising: a base plate member enabling ready attachment to an external vehicle proximate a vehicle door hinge location, a pivot base plate member pivotally joined to the base plate member at a first pivot axis, the first pivot axis enabling movement between a first closed position proximate the vehicle and a second open position distal the vehicle, a pivotally mounted swing arm member swingably joined to the pivot base plate member at a second pivot axis, the second pivot axis being cantilevered from the first pivot axis by the pivot base plate member, the first pivot axis orthogonal to the first pivot axis, and door plate means for securing an external vehicle door to the swing arm.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a front perspective view of one embodiment of the present vertical door kit (VDK) assembly.

FIG. 2 is a rear perspective view of the embodiment of FIG. 1.

FIG. 3 is a top view of the present VDK assembly in a partially open position displaying a selected range of motion of the present invention.

FIG. 4 is a front side view of the embodiment in FIG. 1 assembled with a pair of movement control devices.

FIG. 6 is a rear side perspective view of FIG. 4.

FIG. 7 is a close-up perspective view of the hinge mechanism from FIG. 6.

FIG. 8 is an illustrative perspective view of the swing arm according to one embodiment of the present invention.

FIG. 9 is a side view of the hinge door mechanism according to on embodiment of the present invention.

FIG. 10 is top perspective view of the hinge mechanism locating pivot axis 10 for outward movement of the mechanism away from the vehicle.

FIG. 11 is an illustrative perspective view of one entire embodiment of the present invention in a door-closed position.

FIG. 12 is a top view of an assembled adjustable door kit prior to shipping according to one of the embodiments of the present invention.

FIG. 13 is a side view of an alternative embodiment of the present invention in a closed-door position with additional rigidizing support brackets.

FIG. 13A is a side view of the alternative embodiment of FIG. 13 in an open-door position

FIG. 13B is clear view of FIG. 13 noting all automobile parts positions.

FIG. 14 is a top view of an assembled door hinge unit with multiple adjustment positions.

FIG. 15 is an alternative embodiment of a base plate or mounting bracket positioned on a frame chassis member.

FIG. 16 is a side view of another alternative embodiment of the present invention shown in an open-door position.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below, as well as directional pivot-arrows, may be used with respect to the drawings.

These and similar directional terms should not be construed to limit the scope of the invention in any manner. The words “connect,” “couple,” and similar terms with their inflectional morphemes do not necessarily denote direct and immediate connections, but also include connections through mediate elements or devices.

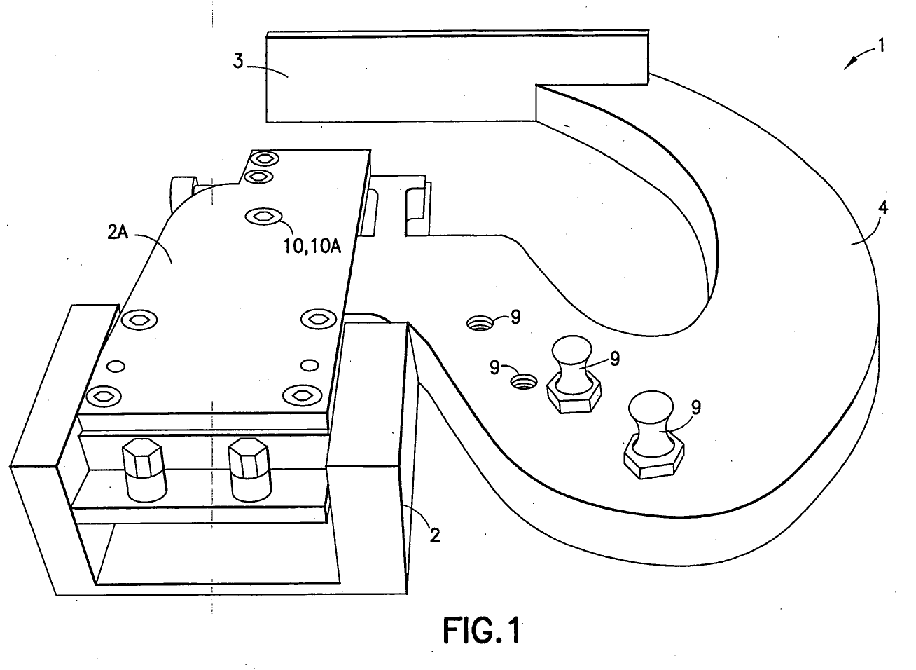

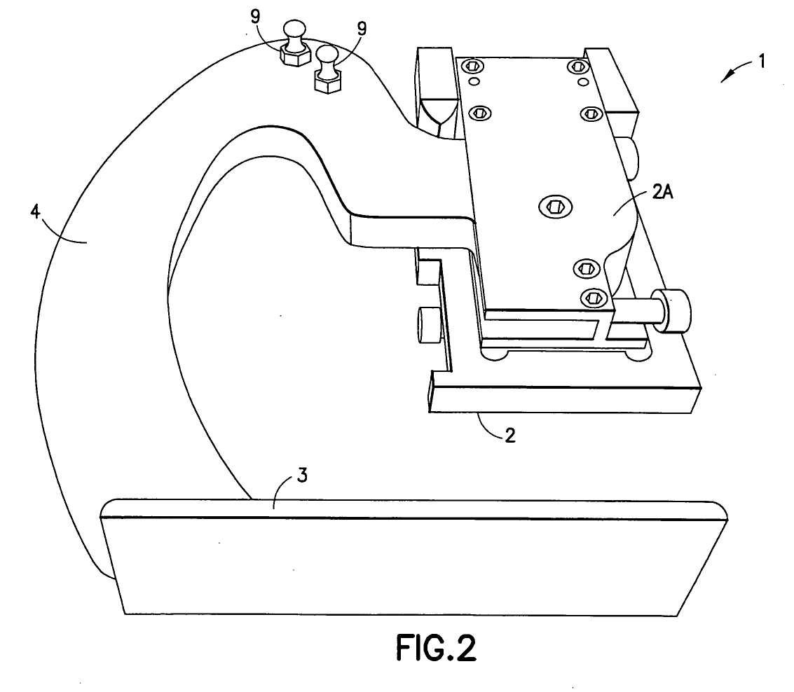

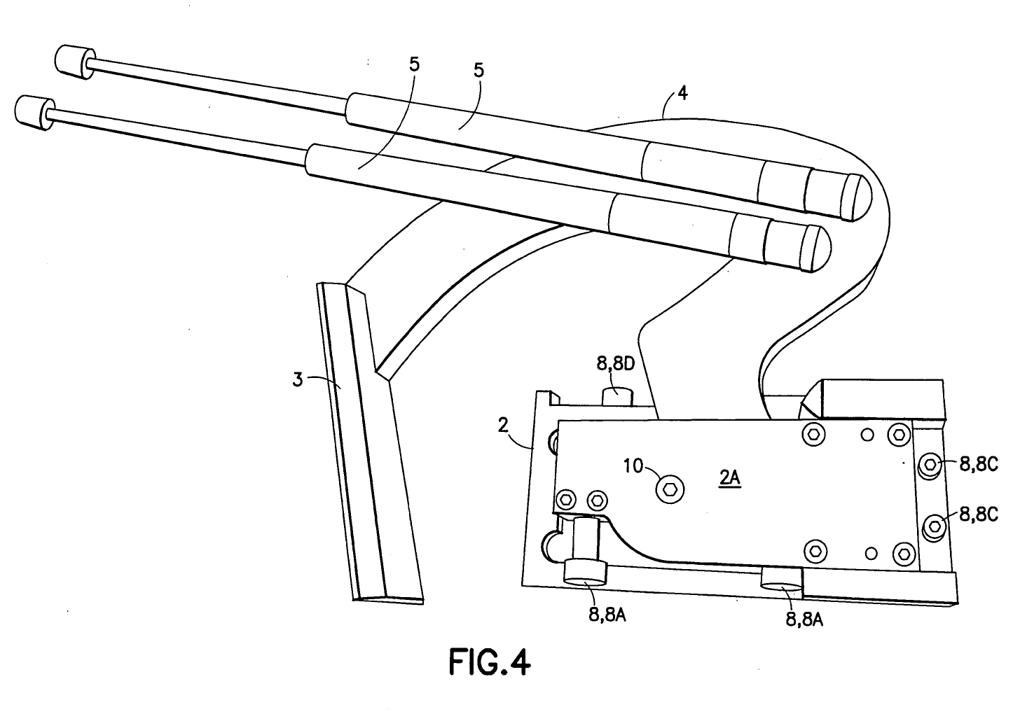

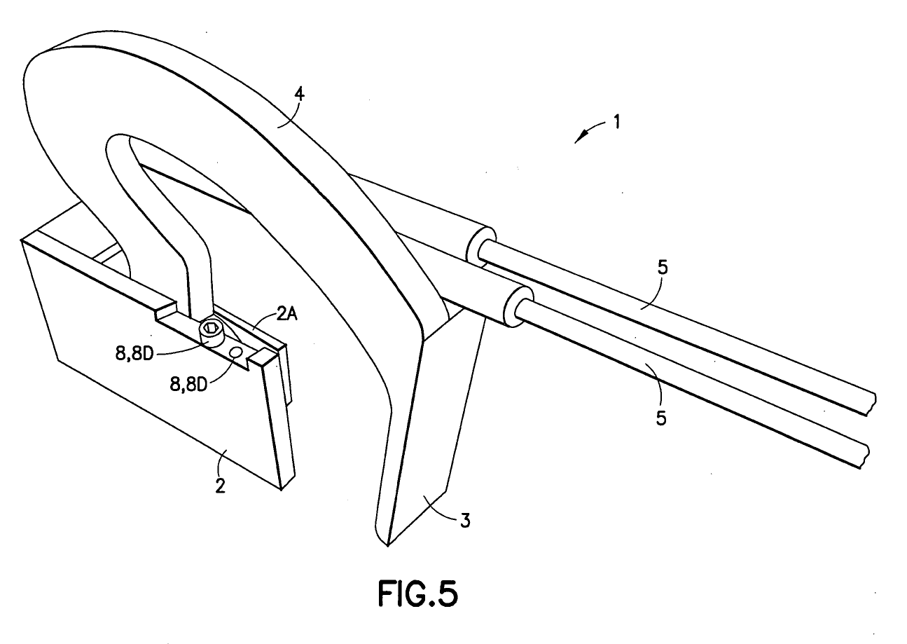

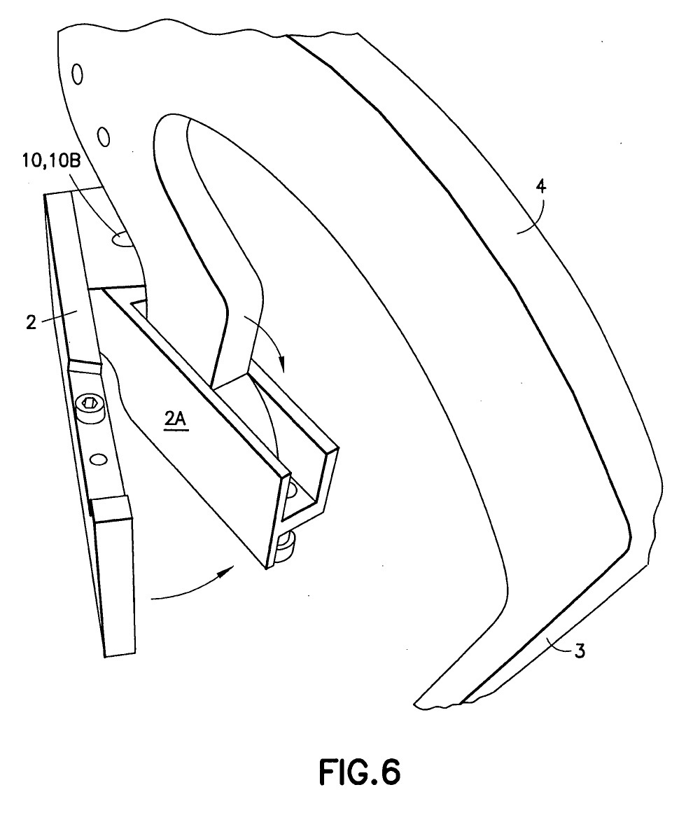

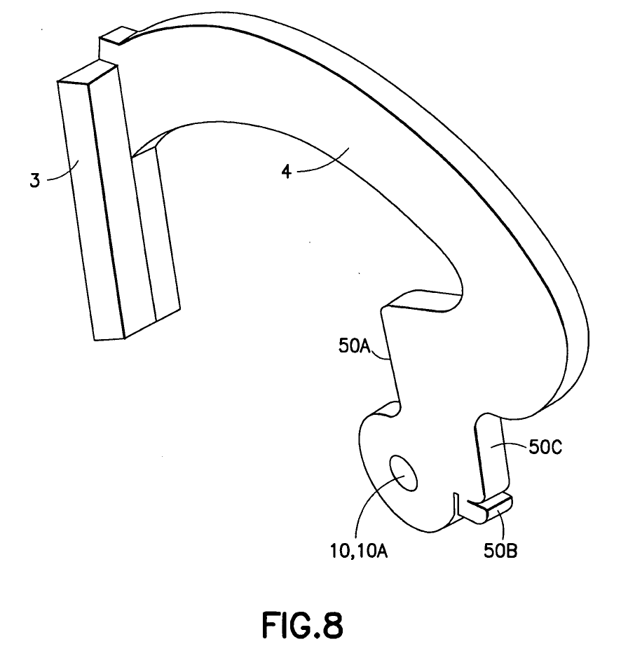

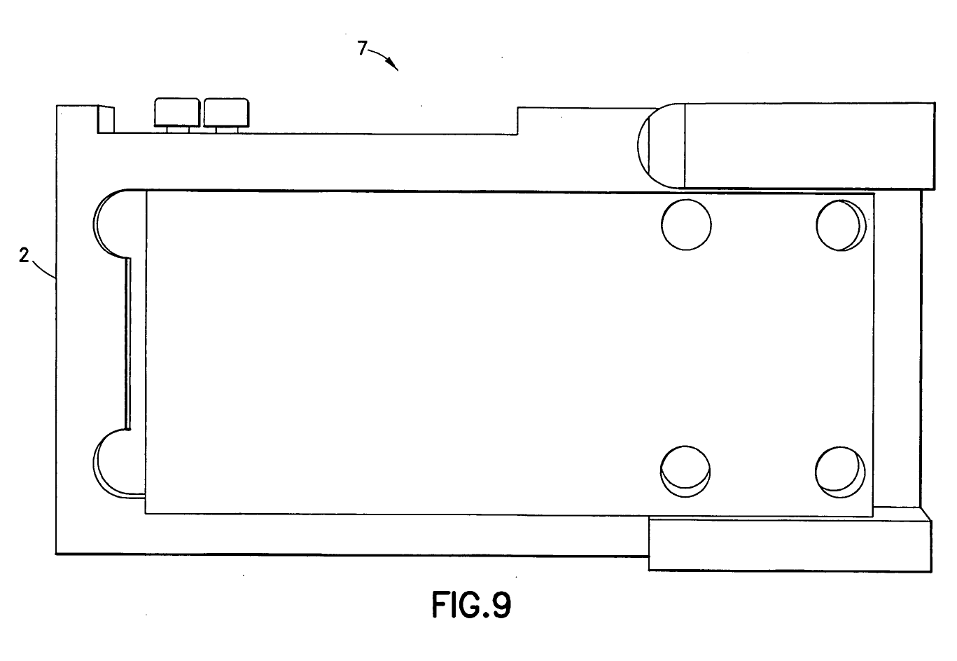

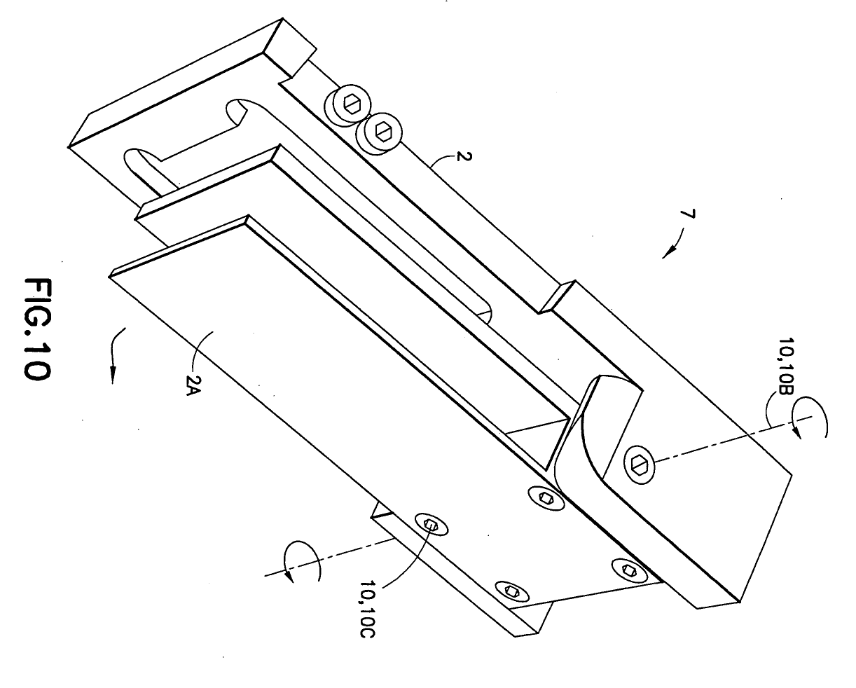

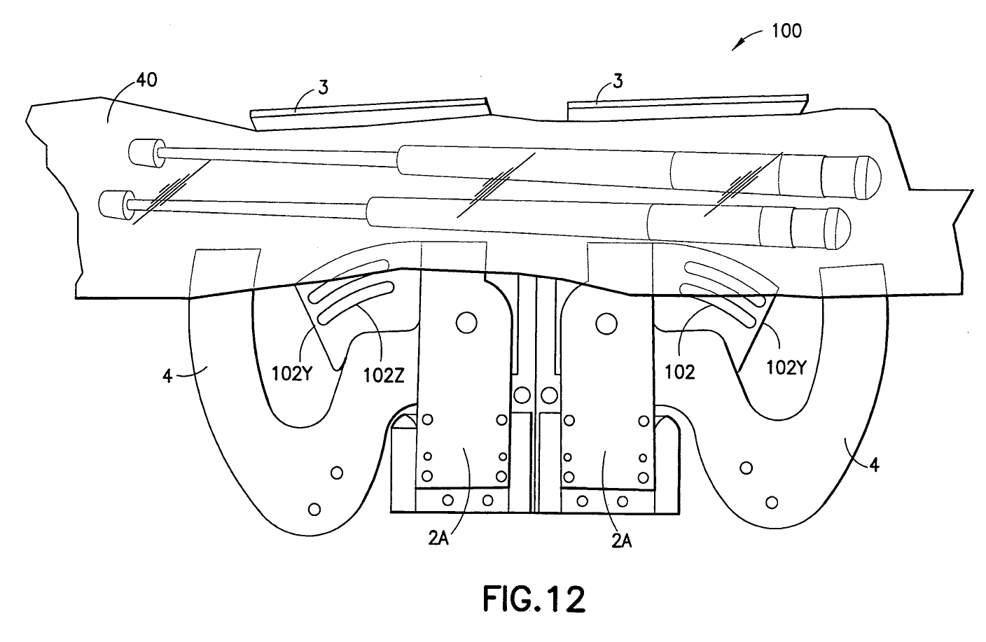

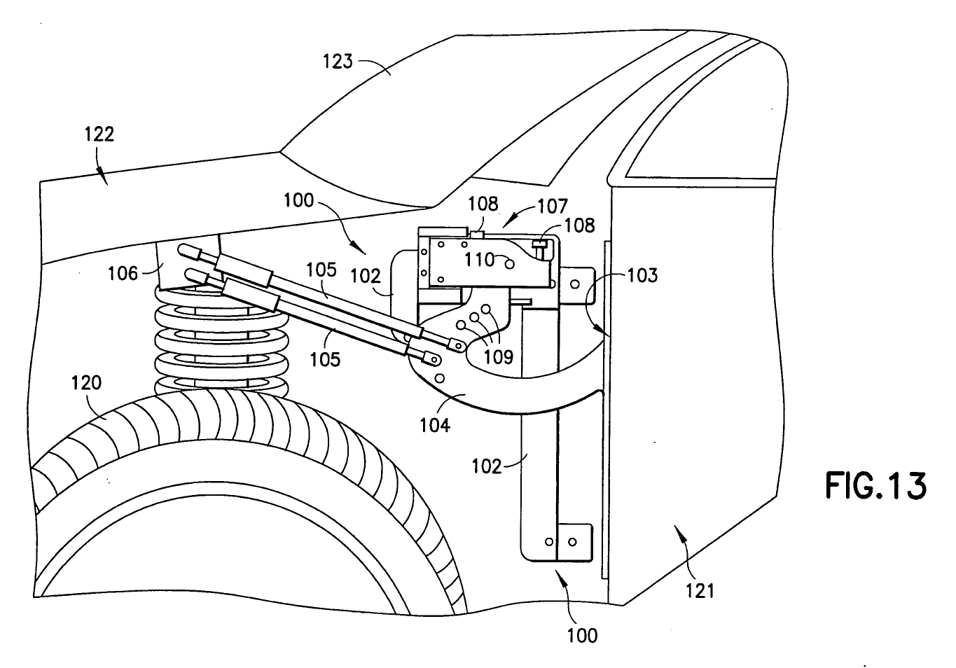

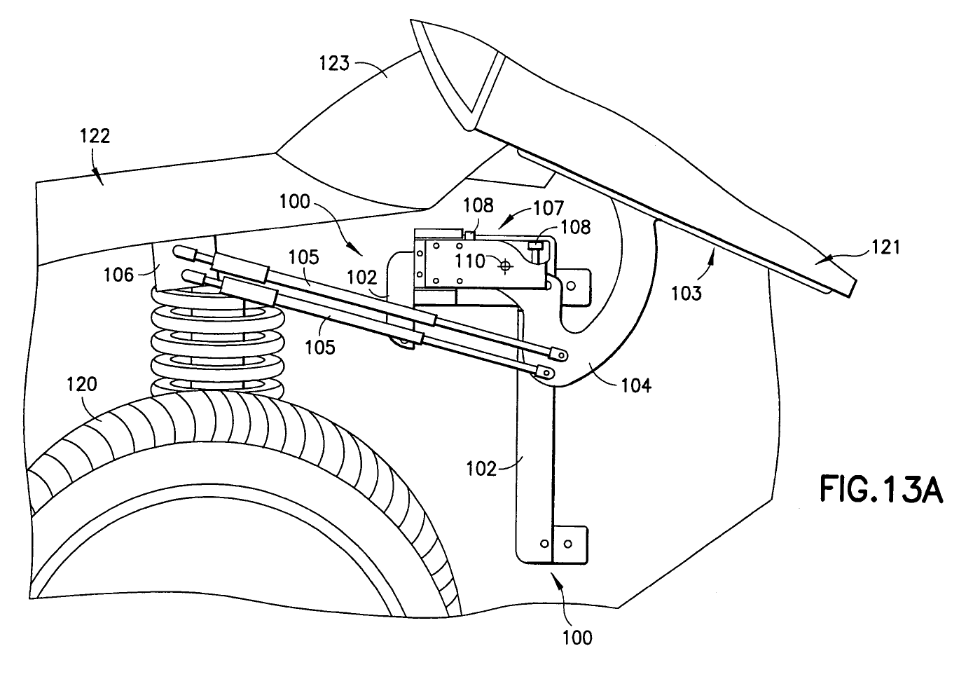

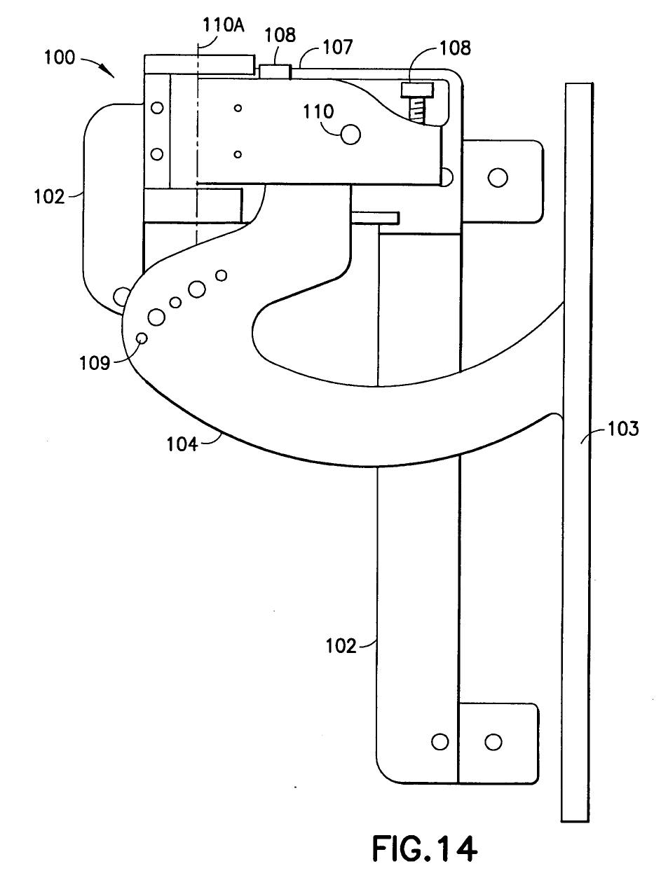

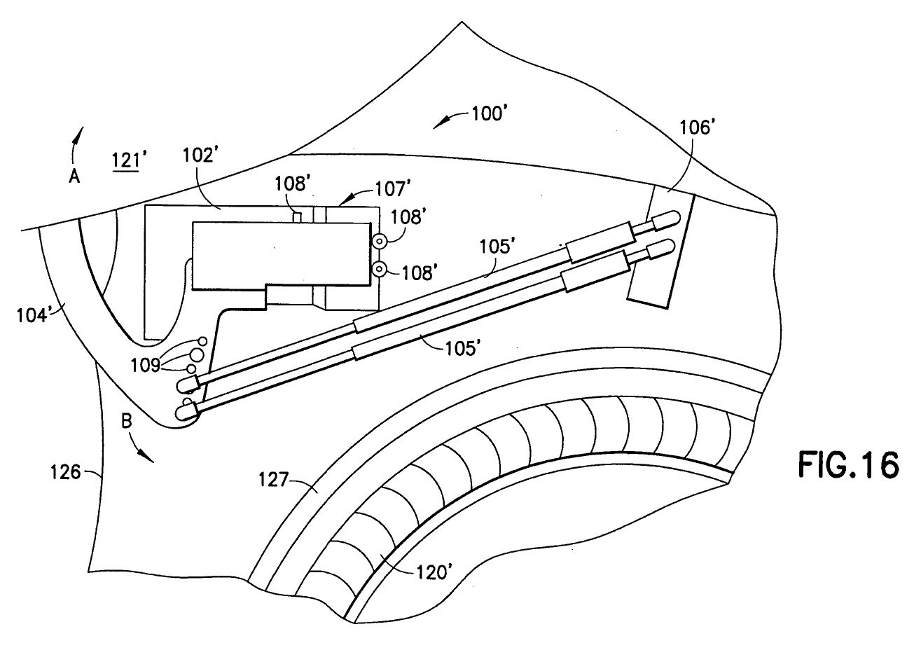

Referring now to FIG. 1 through FIG. 16, a Vertical Door Kit (VDK) mechanism 1 includes a base plate or mounting bracket 2, having a pivot base plate member 2A, a door plate or mounting bracket 3, a swing arm 4, and one or more mounting control devices 5 (commonly gas charged lift supports) joining pivoting control points 9 to frame mounting brackets 106, 106′ (shown in FIG. 13 and FIG. 16).

Within mechanism 1, a hinge assembly 7, and a plurality of adjustment screws 8 (in some embodiments controlling one or more of a door sag, an outward door motion, a safety set screw, and a door height adjust screw).

As shown there are a plurality of pivot axis 10, including a pivot axis 10A for swing arm 4, and a pivot axis 10B for the swing arm/hinge assembly connection. Pivot axes 10 are generally positioned orthogonal to one another throughout a common range of movement. Pivot axes 10 operate together to enable the combined outward and upward motion of the door during use.

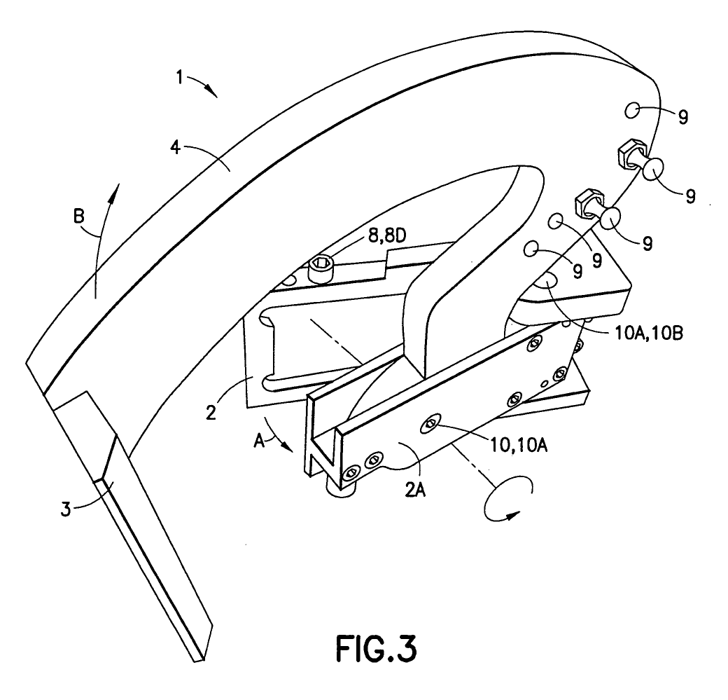

Referring now to FIG. 3, a plurality of control points or pivot points 9, 109 for pivotally receiving control devices 5 are arrayed about an initial arc of swing arm 4, 104. It should be understood, that as shown pivot points 9 are threaded openings and commonly operate to receive ball shaped or semi-spherical pivot points enabling both an outward and rotational pivoting of control devices 5 relative to swing arm 4.

It should be clear to those of skill in the art, that in combination with control devices 5, pivot points 9,109 and the array of openings (shown) along swing arm 4 enable a wide adjustment of mechanism 1 to accommodate vehicle doors of variable weight and shape. Such an enabling design also readily adapts to adjusting a rate-of-door-opening to a user's convenience and safety.

Referring now to FIG. 3, hinge assembly 7 is shown in an outward-wing (See arrow A) thereby allowing swing arm 4 to pivot along arrow B to a door-open position. During assembly, an external doors is affixed to mechanism 1, and hence the vehicle via attachment to door plate 3 prior to upward motion. This swing out motion enables a car door to adjust and clear the car fender and chassis.

Referring now to FIGS. 3 through 6 wherein adjustment screws (collectively adjustment screws 8) include a vertical adjust mechanism 8A, a door sag adjustment mechanism 8B, and an outward motion control mechanism 8C, and pivot base plate pivot motion mechanism 8D.

It should be understood, that in combination, adjustment mechanisms are understood to be screws 8, 8A, 8B, 8C, and 8D (and possibly others according to specific embodiments) may be adjusted to control both the outward pivot of hinge assembly members 7 away from the car, but also the upward pivot motion and range of swing arm 4 and a car door, as well as the ultimate closed-door position. As a consequence a simple assembly kit allows multiple adaptations to a wide variety of automobile doors, frame shapes, and vehicle dimensions.

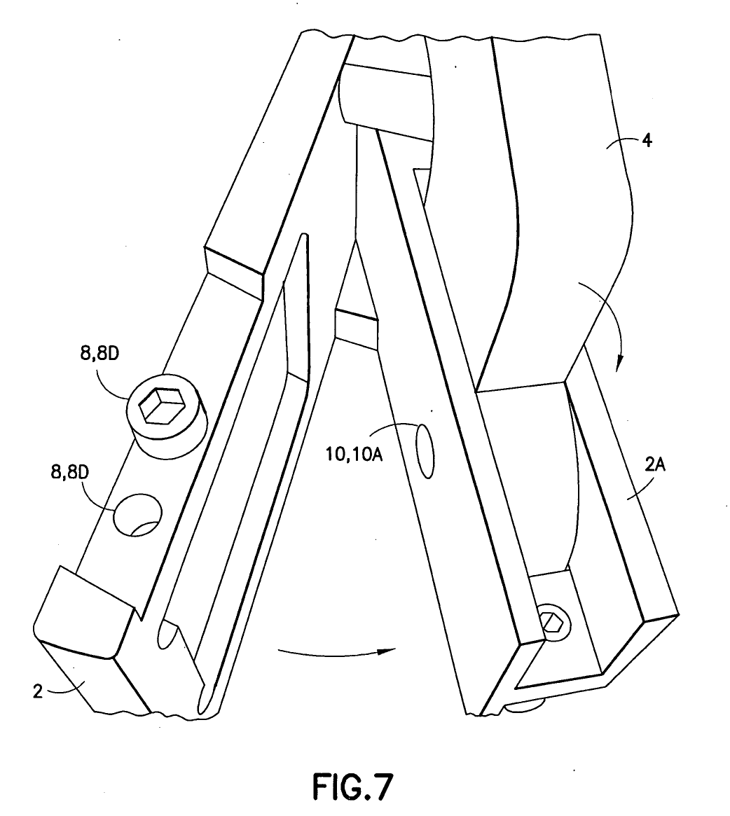

Referring now to FIG. 8, it will be noted by those of skill in the art that respective adjustment mechanisms operate to engage adjustment planes 50A, 50B, and 50C to control the motion of swing arm 3.

As will also be understood by those of skill in the art, door plate member 3, while provided as a stock shape, is intended to be cut, modified, and shaped by an end user to directly connect with an external door. As a consequence, the particular shape of door plate member 3 is not essential to the invention, but it's secure attachment to the end of swing arm 4 is vital to secure operation of the invention after installation. Thus it is envisioned, that door plate member 3 is cut to shape and welded in place, or secured by other suitable mechanisms as will be described herein below.

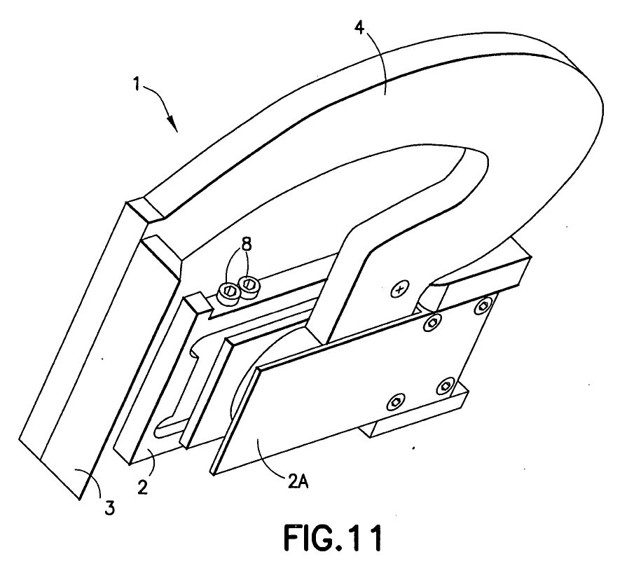

Referring now to FIG. 12, an entire assembly kit 100, includes a pair of pivot mechanism 1, each with respective swing arms 4 and other equipment as noted above. In this embodiment, mounting brackets 102Y project from respective base plate members 2, include adjustment slots 102Z, and operate to enable a user to secure the base plate member to a vehicle side wall initially with bolts (not shown). As a consequence of this improvement, a user may initially position assembly 1 with bolts (not shown), and then adjust placement via slots 102Z until a final desired position is achieved, then tighten the bolts, and weld base plate member 2 in it's permanent position.

Referring directly now to FIGS. 13 through 16, alternative embodiments of the present invention display differently shaped mounting brackets, and support extensions for adaptation to vehicles with limited positions, strengthening of the mechanism to prohibit the need for adjustment over time.

Here, an alternative embodiment of the present invention provides a mechanism 100, 100′ having a base plate or mounting bracket 102, 102′ with associated pivot base plate members 102A, 102′A, and a door plate or door mounting bracket 103 joined by a swing arm 104, 104′ and a hinge assembly 107, 107′.

A series of control points 109. 109′ on respective swing arms 104, 104′ are joined to a mounting bracket 106, 106′ by control devices 105 enabling safe operation and secure adjustment.

As can be seen, mechanism 100, 100′ includes an unusually shaped base plate 102, 102′ adapted to a particular embodiment requiring long and thin attachment points. Base plate 102 includes an opposite side attachment point (as shown) allowing for a 3-point attachment to increase strength.

Door plate 103 is extended in the present embodiment to enable bolting or welding to a door panel. It will be understood by those of skill in the art, that door plate 103 may take many forms and shapes to facilitate attachment, welding, bolting, etc., without departing from the spirit and scope of the present invention.

As can be seen a conventional wheel 120, a door 121, a hood 122, a windshield 123, a body panel 124, and a door opening 126 serve to place mechanism 100, 100′ in context. In all cases, the present invention enables simple and secure attachment to a wide variety of vehicles via both welding and bolting and other common forms of joining.

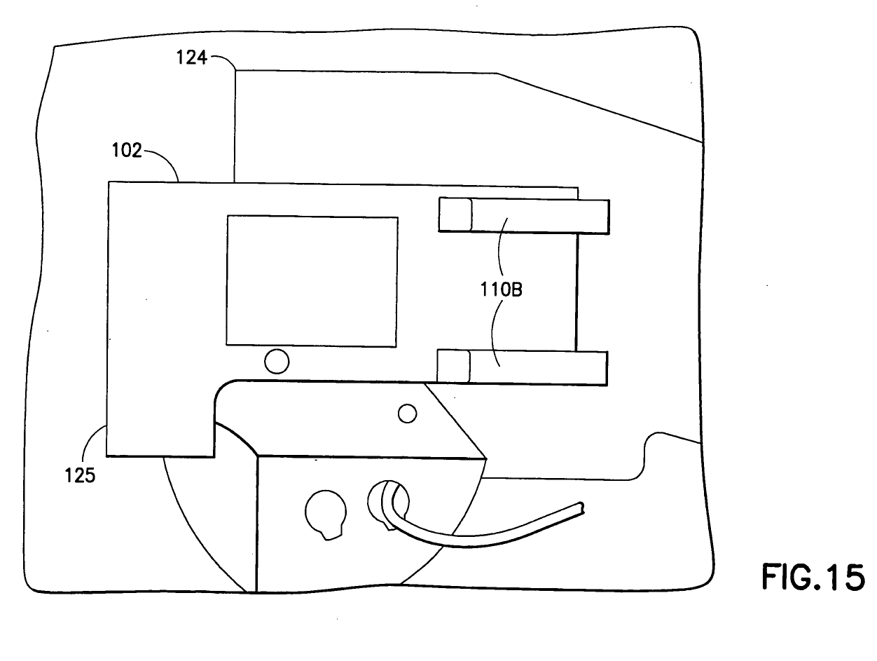

Referring specifically now to FIG. 15 a base p late or mounting bracket 102 is joined to a car body or chassis 124 and positioned as shown. Bracket 102 is joined to the vehicle by welding along a seam 125 for increased strength. A plurality of pivot holes 110B are visible to enable hinge mechanism 107 to pivot away from the car.

Referring now directly to FIG. 16, another alternative embodiment of the present invention provides mechanism 100′ having a base plate or mounting bracket 102′ and a door plate or door mounting bracket 103′ joined by a swing arm 104′ and a hinge assembly 107′.

Control points 109′ on swing arm 104′ are joined to a mounting bracket 106′ by control devices 105′. As can be seen, mechanism 100′ includes an unusually shaped base plate 102′ adapted to a particular embodiment and suitable for the vehicle. Base plate 102′ includes an opposite side attachment point allowing for a 3-point attachment to increase strength.

Door plate 3, 103 (not shown) is extended in the present embodiment to enable fixing to a door panel. As can be seen, a door 121′ pivots relative to wheel 120′, and door opening 126′ both first in an outward direction B away from door opening 126, and later an upward direction A to allow user access.

Based on the initial assembly mechanism discussed, the following is a broad-brush assembly or installation process according to one embodiment of the present invention:

Steps:

I. Remove fender and wheel well liner. As needed, remove the headlights and bumper if they cover the fasteners for the fenders. If a fender has been smoothed into the side skirt because of previous custom bodywork, it must be cut.

II. Remove the door panel and lower dash panels to loosen the wires going through the door jam by cutting ties that keep the wires bunched up and pull extra slack towards door jam. Pull the stock rubber boot out of the door and door jam.

III. Open the door and disconnect the door stop from the door jam.

IV. With the door closed, remove the factory top door hinge.

V. Test the placement of the VDK mechanism 1 by holding it against the chassis. Determine the highest mounting point available without the mechanism hitting the fender when it swings outwardly. This position will give maximum swing arm to fender clearance when the door is up. If the mechanism is mounted too high it will limit the open outward angle of the door. The present invention is readily adjustable to each vehicle model, and allows the unit to find the best fit by test-fitting with the fender.

VI. Open the mechanism 1, and extend the swing arm 4 up and test the placement against the vehicle chassis again. Have an assistant slide the fender in place while you hold the swing arm to test fender clearance when the door will be up. Observe anything that may prevent the base plate 2 and door plate 3 from sitting flushed, then grind or hammer any extrusions that may hinder the base plates from sitting flat. An installer may also grind and cut the base plate and door plate as needed.

VII. In cars with small spaces between the chassis surface and the fender there will not be sufficient room to swing the door horizontally before it goes up. In this situation one must draw a line around the base plate when it is in the proper position, and then cut along the perimeter to allow the base plate to slide below the surface.

VIII. Estimate how far the horizontal swing will be and adjust the safety arch accordingly via adjustment means 8. Cut a slot in the chassis to accommodate the arch, and if the base plate is below the chassis surface for an application one will need to make additional space for adjustments.

IX. Next one should cover the VDK mechanism in masking tape and or welding deflection paper except the surface that will touch the car and get welded. This will protect the vehicle finish during installation.

X. While holding the VDK mechanism in place, tack weld spots around the perimeter of the base plate and door plate. When one feel the welds are sturdy enough based upon personal experience, one may test the door's motion by swinging it out and up manually. It is through installer-observation of the door's action that one will be able to mount the lifting arms, roll the inside of the fender, and make any necessary adjustments at the door sag screws, outward motion screws, safety set screw and door height screws collectively referred to as adjustment screws 8.

XI. Hold the fender in place to observe where the swing arm will interfere, if at all. Cut or roll the inner lip to provide clearance for the swing arm. Test door motion again with fender properly cut.

XII. Once an installer is satisfied with the operation and placement of the hinge, make a strong weld around the entire perimeter of the base-plate and door-plate.

XIII. Grind the welds and scuff the surrounding area. Mask the VDK mechanism and other parts one does not want covered in undercoat fluid. To prevent rust, one will have to undercoat, paint, or silicone the welds for complete protection.

XIV. Lube the moving surfaces of the VDK mechanism with heavy waterproof grease while the door is still off of the car. Replace the door on the car by sliding the VDK mechanism together and tap in the vertical pin.

XV. Secure lengthened wires to the underside of the swing arm with zip ties.

XVI. To mount the gas charged lift supports (control devices 5), screw two ball joints (shown in FIG. 1 in holes 9) into swing arm 4 using a half inch socket. Next measure where the bottom arm will go by holding it so that arm is 4 over the bottom ball joint and the body is back enough to clear the end fitting if it was fully compressed. Then with the body just above the wheel well liner, mark the spot where the ball joint will get mounted on the chassis. Now with the top motion screw out and the hood closed, swing door up to its maximum vertical point. Click in the fitting for the top lifting arm to the top ball joint on the swing arm and mark opposite side on chassis about 1.5 inches above the bottom arms ball joint mark. Click in the bottom arm to the swing arm. Have a helper swing the door out then up while holding the arms parallel near the chassis. Test the motion. Those skilled in the art will take note that arms stay parallel as an assistant lifts the door up and down. Ensure the lifting arms do not hit each other or the hinge in the course of the door's motion.

XVII. Put the door down and weld a piece of flat stock steel onto the chassis to reinforce it where you marked the ball joint spots as a mounting bracket. Drill and tap the metal for the ball joints or drill and weld them in place. Mask the ball joint tips, and spray undercoat. Now lift the door all the way up and pop the lifting arms into the ball joints.

XVIII. The door will now stay in position when it is up. Test the door's motion again and make any adjustments necessary adjustments to adjustment screws 8. It is recommended to add Loc-Tite® to all adjustments.

XIX. With the door closed, tighten up the door sag screw. Test the door's horizontal motion until the door is aligned with the latch and closes perfectly. Adjust the safety arch until the VDK mechanism no longer interferes with the fender when the door is all the way out horizontally. Then set the horizontal motion screws to correspond with the angle that the safety arch rubs the inside of the lifting arm when up. The closer you make these two adjustments, the more sturdy the door will feel going up and resting in the vertical position. Set the vertical height limiter adjustment as high as you wish provided that the door does not hit the fender or hood when propped up.

XX. If the door panel and/or door metal hits the fender or comes too close to the fender on the way up it, must be cut. Additionally, should the door panel be cut first, mark a line that will allow clearance prior to cutting. Then peel back the upholstery, make the cut, and wrap the upholstery over the new edge with spray adhesive.

XXI. Mount the fender (lights, bumper and side skirts) to complete the installation process.

Those of skill in the art will recognize that the present invention includes innovations in the areas of adjustment, range of motion, ready adaptation to multiple vehicle designs, security of operation, and safety of operation.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An adjustable door kit assembly, comprising:
a base plate member enabling ready attachment to an external vehicle proximate a vehicle door hinge location;
a pivot base plate member pivotally joined to the base plate member at a first pivot axis, the first pivot axis enabling movement between a first closed position proximate the vehicle and a second open position distal the vehicle;
a pivotally mounted swing arm member swingably joined to the pivot base plate member at a second pivot axis;
the second pivot axis being cantilevered from the first pivot axis by the pivot base plate member;
the first pivot axis orthogonal to the first pivot axis; and
door plate means for securing an external vehicle door to the swing arm.
